(19) United States
(12) Patent Application Publication
(10) Pub. No.: US 2017/0297479 A1
(43) Pub. Date: Oct. 19, 2017

(54) VEHICLE LIGHTING DEVICE WITH MEANS FOR LOCATING AN ELECTRONIC CARD

(71) Applicant: VALEO VISION BELGIQUE, Meslin L'Eveque (BE)

(72) Inventors: Florestan DEBERT, Nomain (FR); Jean-Francois DELOURME, Wattrelos (FR); Franck DINANT, Virginal (BE)

(73) Assignee: VALEO VISION BELGIQUE, Meslin L'Eveque (BE)

(21) Appl. No.: 15/512,891

(22) PCT Filed: Sep. 25, 2015
(86) PCT No.: PCT/EP2015/072070

§ 371 Date: Mar. 21, 2017

(30) Foreign Application Priority Data
Sep. 30, 2014 (FR) 1459276

(51) Int. Cl. B60Q 1/20; F21S 8/10; B60Q 1/068; F21Y 2115/10

(52) U.S. Cl. CPC B60Q 1/20; F21S 48/328; F21S 48/1721; F21S 48/1233; F21S 48/115; B60Q 1/0683; F21Y 2115/10

(57) ABSTRACT

A motor vehicle lighting device including: a housing closed by a transparent outer lens; an electronic card inside the housing connected or configured to be connected to a light source, the electronic card including a locating tab. The housing includes at least one locating portion arranged with the locating tab so that the electronic card is located relative to the housing by the contact engagement of the locating portion and the locating tab.

The present invention concerns a lighting device, notably for motor vehicles. The present invention more particularly concerns a device in which an electronic card is placed inside the housing. This electronic card is connected to or intended to be connected to a light source, for example a light-emitting diode (LED).

In accordance with some embodiments of vehicle lighting devices, it is important to locate correctly the printed circuit card that it contains. For example, the card may carry a light source and it must then be precisely located. Also, the connection area may be precisely defined in the housing and the card must then be correctly located relative to it.

For example, the document US2011/0103076 A1 describes a module including a ring provided with a connector, in which ring an electronic card is fitted. The connector enables the electrical connection of the module and is connected to the card. This ring serves as an intermediary for fixing the module in a vehicle lamp and also includes a pair of lugs serving as a reference for and to locate this module in this lamp. This system includes numerous parts, however, and therefore as many difficulties in locating these parts relative to one another.

The technical problem addressed by the invention is therefore that of obtaining a vehicle lighting device that is simpler to produce.

To this end, the invention consists firstly in a motor vehicle lighting device including:
a housing,
an outer lens closing a front opening of the housing and transparent to allow the light rays emitted by said lighting device to pass through it,
an electronic card inside the housing connected directly or indirectly or intended to be connected directly or indirectly to a light source, the electronic card having a locating tab,
   the housing having at least one locating portion arranged with said locating tab so that the electronic card is located relative to the housing by the contact engagement of said locating portion and said locating tab.

The electronic card and the means for locating this card therefore form one and the same part. The card is notably formed by a board, referred to as the substrate, notably made of polymer, on or in which conductive tracks are formed. Electronic components are fixed to this board and connected to these tracks. The tab is formed by the shape of an edge of this board, for example, and therefore of the card, or the shape of an opening in this board, and therefore the card. The electronic card is therefore directly located in the housing by the card itself. Moreover, this location is effected directly on the housing of the lighting device. The embodiment in accordance with the invention is therefore very simply.

The invention may optionally have one or more of the following features:
said locating tab is formed on a portion of the peripheral edge of the electronic card; this makes it possible to allow more freedom in the production and the disposition of the electrical tracks of the electronic card and the layout of the electronic components thereon;
said locating tab and said locating portion are arranged so as to be able to slide one against the other when assembling the electronic card into the housing, notably in translation in a given rectilinear direction, notably from the front toward the rear of the housing; location is improved; moreover, the locating portion will be able to guide the locating tab to locate it precisely in the housing when assembling the lighting device in accordance with the invention; production of the latter is therefore facilitated;
the housing includes connecting orifices, the electronic card including connecting pins for the supply of electrical power to the electronic card, said pins passing through these connecting orifices; this enables direct connection of the electronic card to the vehicle in which the lighting device is intended to be mounted; moreover, when these features are combined with those described in the preceding paragraph, the insertion of the pins into the connecting orifices is facilitated, and these pins are subjected to lower mechanical stresses; the stresses on fixing the pins to the electronic card and the corresponding risks of damage are therefore also reduced;
said locating tab is formed on a portion of the peripheral edge of the electronic card that is nearest the connecting pins; this makes it possible to improve further the guidance of the pins in the connecting orifices and therefore to reduce further the mechanical stresses on the pins and on the fixing thereof to the electronic card when assembling the lighting device;
the connecting pins and the connecting orifices are oriented in a rectilinear direction from the front toward the rear of the housing; this enables simple assembly of the electronic card in the housing;
the connecting orifices are on a back wall of the housing, i.e. at the rear of the latter; the connection to the vehicle is simpler; this also facilitates embodiments with an electronic card oriented perpendicularly to the direction of emission of the light beam by the device in accordance with the invention;
said locating portion is a groove in a wall of the housing extending toward the connecting orifices, the locating tab being accommodated in this groove; this enables precise guidance of the connecting pins in the connecting orifices when assembling the lighting device;
said locating portion is a groove in the wall of the housing, the locating tab being accommodated in this groove; the groove is a shape that is simple to produce and enables guidance of the locating tab;
the groove extends in a rectilinear direction from the front toward the rear of the housing; this facilitates mounting the electronic card from the front;
the housing includes a globally cylindrical wall closed at the rear by a back wall, the cylindrical wall having a cylinder axis extending from the front toward the rear of the housing, the groove being formed on this cylindrical wall; the device is therefore both easily adaptable to a vehicle front panel and easier to assemble by mounting the electronic card from the front;
the lighting device includes a mask located between the electronic card and the outer lens, the mask including a bearing member bearing on the locating tab; this makes it possible to make more secure the correct location of the locating tab; moreover, when the housing includes connecting orifices and the electronic card includes connecting pins passing through these orifices, this makes it possible to be sure that the pins are pushed completely through the connecting holes; in some embodiments of the invention in which the casing includes a groove, this bearing member may be accommodated inside the groove, which makes it possible to guide the bearing member precisely;
said bearing member extends in a rectilinear direction from the front toward the rear of the housing; this makes it possible to improve the pressing action, and where applicable the guidance, of the locating tab;
the mask includes a poka-yoke orifice facing the outer lens, said poka-yoke orifice being aligned with said bearing member; this makes it possible to locate the outer lens on the housing when assembling the lighting device in accordance with the invention as well as preventing the formation of a shrink mark on the visible surface of the mask;
the housing includes an abutment, said locating tab being gripped between this abutment and said bearing member, and the abutment may for example be formed on the back wall of the housing and/or at the end of a groove for guiding the locating tab; this makes it possible to improve the pressing action;
the housing includes connecting orifices, the electronic card including connecting pins for the supply of electrical power to the electronic card, said pins passing through these connecting orifices, the connecting orifices being on a back wall of the housing and said abutment being placed between these connecting orifices and the edge of the electronic card, notably the edge area nearest these connecting edges; this makes it possible to ensure more precise location of the pins through the connecting orifices;
said locating tab forms a lug for locating the electronic card; this facilitates its guidance, notably by a groove; for example, the peripheral edges of the card, and therefore of the board carrying the electrical tracks, include two upsets producing this locating lug, notably of rectangular shape;
the light source is a light-emitting diode; it can therefore be supplied with power via an electronic card, directly through the housing;
the electronic card is a control electronic card for the light-emitting diode;
the electronic card is fixed to a support, notably a heatsink, fixed to the housing, notably by elastic nesting, for example directly in protuberances or holes of the housing; assembly is further simplified: the locating tab will guide the location of the pins in the connecting orifices when mounting the heatsink in the housing;
the support of the electronic card is also a support of the light-emitting diode; the latter may be fixed directly to the electronic card or separately to the support;
the lighting device is a fog lamp;
the housing includes a cylindrical portion inside which the light source support, the lens and the presser element are stacked in this order, in a direction parallel to the axis of the cylindrical portion; this therefore simplifies assembly of the lighting device, which is of all the more benefit when the lighting device is a fog lamp, notably intended to be mounted in the front panel of the vehicle;
the mask has a periphery in contact with the edges of the housing; the mask is therefore fitted as closely as possible into the device.

The invention also consists in a vehicle including a lighting device in accordance with the invention.

Other features and advantages of the invention will become apparent on reading the following detailed description of nonlimiting embodiments, to understand which reference should be made to the appended drawings, in which:

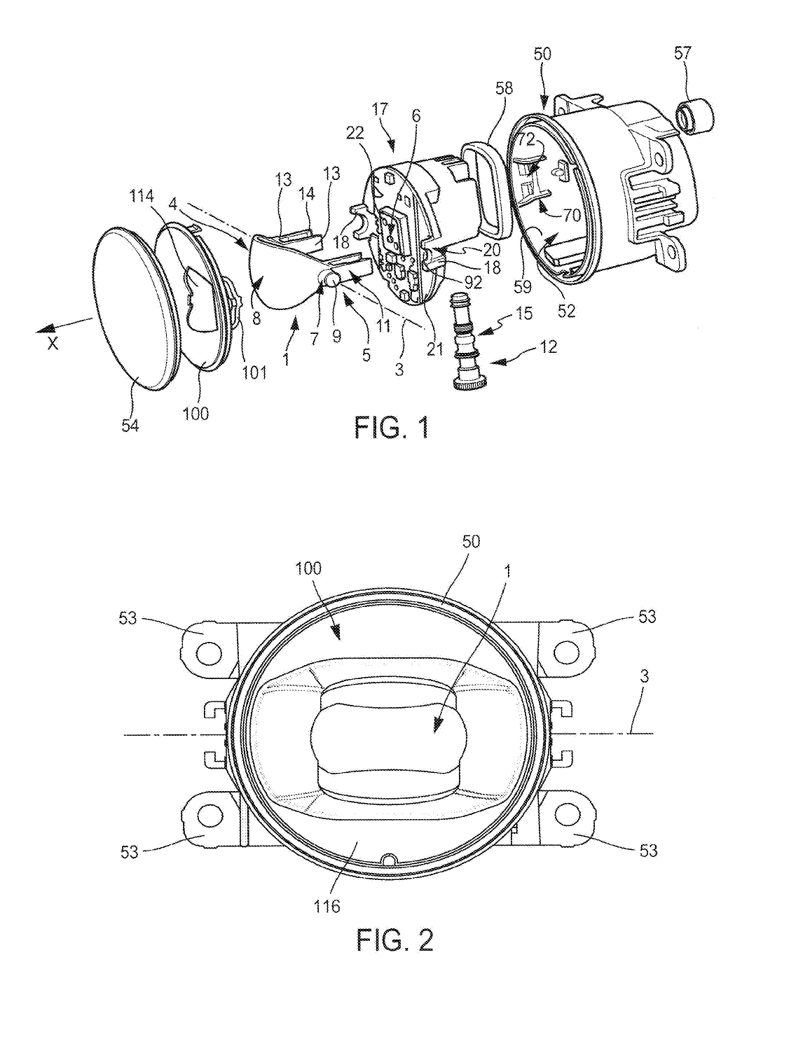

FIG. 1 is an exploded perspective view of a lighting device in accordance with the invention;

FIG. 2 is a front view of the lighting device from FIG. 1, shown assembled;

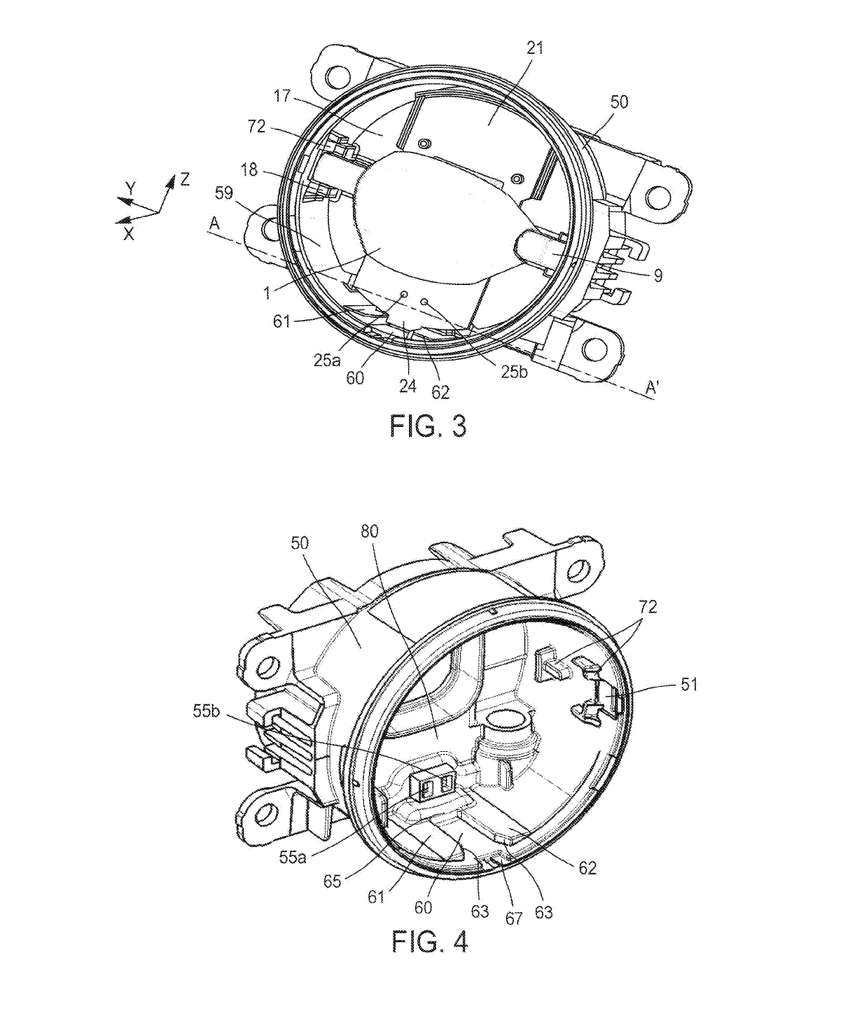

FIG. 3 is a perspective view of the lighting device from FIG. 2 without the outer lens or the mask;

FIG. 4 is a perspective view of the housing of the lighting device from FIG. 1;

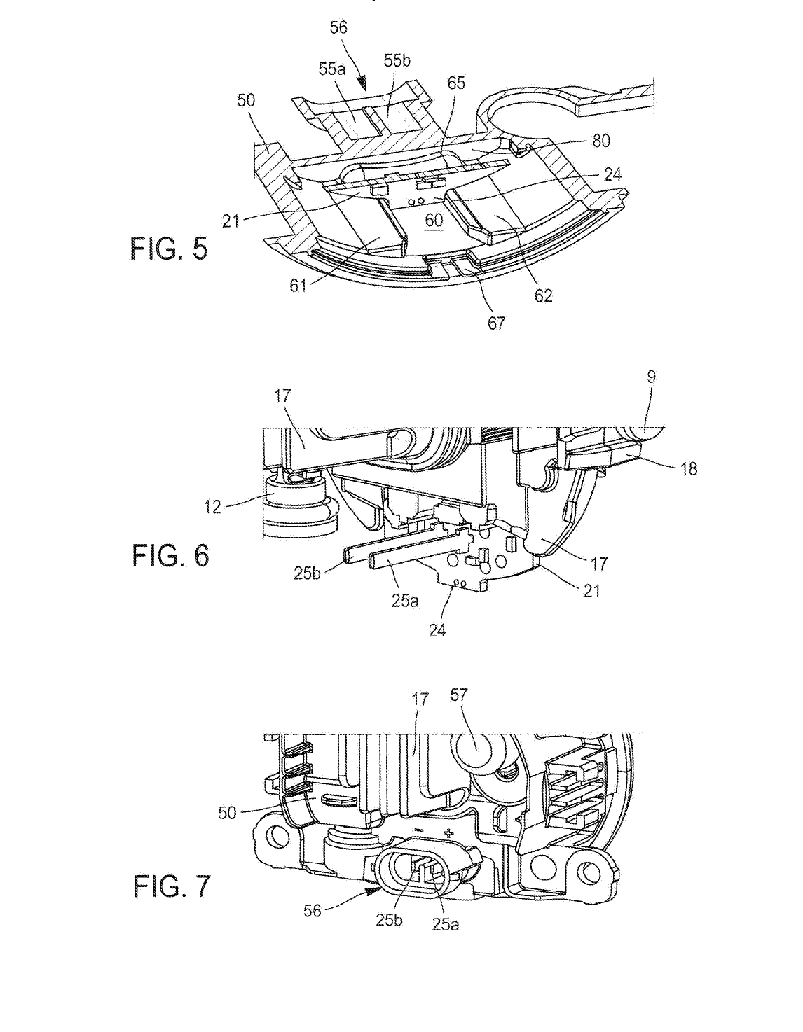

FIG. 5 is a perspective view of FIG. 3 in section on a plane parallel to the plane (x,y) and passing through the axis AA′;

FIG. 6 is a detail perspective view from the rear of part of the electronic card of the lighting device from FIG. 1;

FIG. 7 is a perspective view from the rear of the lighting device shown in FIG. 2;

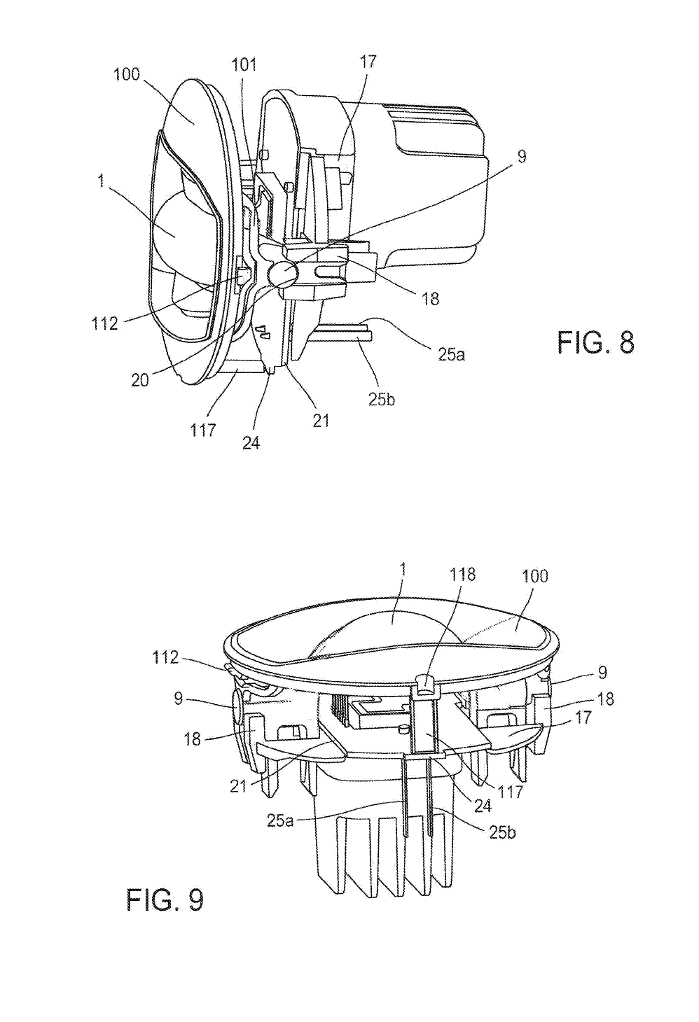

FIG. 8 is a side view slightly in perspective of the lighting device from FIG. 2 without the housing or the outer lens;

FIG. 9 is a bottom view slightly in perspective of FIG. 8.

As shown in FIGS. 1 and 2, the lighting device includes a housing 50 defining an enclosure 52 inside which are disposed a light source 6 and the optical element 1 deflecting its rays. In the classic manner, said lamp includes an outer lens 54 and a styling part or mask 100, situated between said outer lens 54 and the optical element 1, in the direction X of emission of the light beam by the lighting device.

The housing 50 takes the form of a substantially cylindrical envelope, for example. The housing may include fixing lugs 53 intended to be fixed to the vehicle, for example in its front panel.

The lighting device enables the emission of a light beam that is truncated or at least has a very rapid fall-off of the emitted brightness below a certain level corresponding to said cut-off line. For example, the beam is limited below a plane, notably intended to be substantially horizontal and to be located at a certain height above the road.

In the example shown, the device is a lamp generating a fog beam, therefore having a horizontal cut-off line; this lamp is known as a fog light or fog lamp.

In the example shown, the optical element is a lens 1 including an optical part 4 delimited by a rear refracting surface and a front refracting surface. Note that in the present application the terms “front” and “rear” are to be understood relative to the direction of emission of light rays by the lighting device. The front and rear refracting surfaces are arranged so as to produce the cut-off line.

In this example the cut-off line may be produced by a mutual arrangement of the lens 1, notably its front and rear refracting surfaces, and the light source 6, as is known in itself, notably from the documents EP1762776, in particular the embodiments corresponding to FIG. 11 and the subsequent figures, and/or EP1970619, in particular the embodiment of FIG. 1.

The present application is not limited to the type of optical element or elements interacting with the rays emitted by the light source. For example, one or more reflectors could be used or a combination of a reflector and a lens.

The position of the cut-off line is adjusted by varying the angular position of the lens 1 about a rotation axis 3, intended to be oriented along the transverse axis of the vehicle equipped with said lighting device.

The rotation axis 3 advantageously passes substantially through the light source 6. The lens 1 could further have a focus at the level of the light source 6.

In this example, to allow this adjustment, the lens 1 also includes a mobile hinge portion 5 including arms 7 rotatable about the rotation axis 3.

This results in a solution thanks to which the cut-off line is adjusted by actuation of a single member, mainly the lens, serving to transmit the beam.

In accordance with this example, the light source 6 may be a light-emitting diode (LED) placed upstream of the lens 1 in the direction of emission of the light beam by the lighting device.

The support 17 of this light source 6 is fixed directly to the housing 50 of the lighting device. It locates and therefore fixes the source in the housing 50.

Here the light source support 17 further includes a control electronic card 21. This card 21 is notably used for controlling said light source 6.

The fixing of the light source support 17 therefore also indirect fixes the control electronic card 21. This is not limiting on the invention, however, and separate supports could be provided for the light source 6 and its control electronic card 21.

Arms 18 of the light source support 17 extend on either side of said control card 21 along the rotation axis 3. As will be shown hereinafter, these arms 18 of the support will form with the protuberances 101 of the mask 100 an enclosure inside which journals 9 of the arms 7 will be able to turn about the rotation axis 3.

The control electronic card 21 is advantageously radially offset relative to the light source 6 along the rotation axis, that is to say, here, longitudinally along the global emission axis 3 of the light source. In other words, said light source 6 is raised relative to the control card 21. This facilitates the passage of the rotation axis 3 through the light source 6.

To be more precise, here said light source 6 is situated at the level of a dedicated electronic card 22 of said device and said dedicated electronic card 22 is raised relative to said control card 21, in the direction of the rotation axis 3. Said dedicated card includes, for example, a substrate such as an SMI substrate forming a board, while said control card 21 includes, for example, a substrate such as an FR4 substrate, forming another board. Said dedicated electronic card 22 is carried by said control electronic card 21.

In this example the light source support 17 is a heatsink. This heatsink 17 is more particularly in thermal exchange relationship with the LED, notably via said dedicated electronic card 22.

Said housing 50 includes a lateral internal face 59, which is notably cylindrical, provided with ribs 70 for guiding said articulation arms 18 of the light source support 17. Said guide ribs 70 contribute to the fixing of said light source support 17 in said housing 50 by way of said articulation arms 18 of the light source support 17.

Said internal face 59 of the housing 50 could further include clipping ribs 72, namely elastic nesting ribs, for fixing the light source support 17 by means complementary to these ribs. The latter may comprise the edges of the arms 18 of the light source support 17, as can be seen in FIG. 3.

As shown in FIG. 1, the lighting device in accordance with the invention could be mounted in the housing 50 from the front. The housing 50 is then closed at its end opposite that of the outer lens 54 by a back wall 80, seen in FIG. 4. Said guide ribs 70 and/or said clipping ribs 72 are then open toward the front.

The lighting device in accordance with the invention could therefore be assembled by stacking the light source support 17, the lens 1 and the mask 100 in and toward the back of the housing 50. The components will simply be fixed by nesting the light source support 17 on the internal wall of the housing 50. The lens 1 is then placed facing the light source 6. This produces the assembly shown in FIG. 3.

When it will be mounted on a vehicle, the lighting device will be connected to the electrical power supply provided by the battery of the vehicle.

To this end, as shown in FIG. 7, it includes a connector 56 at the rear of the lighting device. This connector includes two connecting pins 25a and 25b. The latter pins are connected to the control card 21 and pass out of the housing 50, where they are protected by an oblong protection skirt.

To this end, and as shown in FIG. 4, the housing 50 includes two connecting orifices 55a and 55b through the back wall 80 of the housing 50.

In accordance with the invention and as shown in FIG. 6, the lighting device is a simple embodiment in which the connecting pins 25a and 25b are fixed directly to the control electronic card 21, at the rear of this card in this example.

In this example, the control electronic card 21 projects from its support 17 so that the pins 25a and 25b pass alongside this support and remain accessible.

The pins 25a and 25b may be connected to the control electronic card 21 by pushing them through this card (as shown in these figures) and/or by soldering them.

To locate the connecting pins 25a and 25b correctly through the corresponding connecting orifices 55a and 55b when assembling the control electronic card into the housing 50, the housing is equipped with a locating portion 60. This takes the form of a groove 60 between two upsets 61 and 62 formed on the lower portion of the cylindrical part of the envelope of the housing 50. The groove 60 extends from an area near the mask 100 toward the rear of the housing 50, as far as an abutment 65 close to the back wall 80. The connecting orifices 55a and 55b are formed above this abutment 65.

The control electronic card 21 has edges defining edge surfaces of this card. These edges therefore correspond to those of the polymer board of the electronic card 21. This board carries different electronic components interconnected by electrical tracks.

As can be seen in FIGS. 3 and 5, this control electronic card 21, in particular its edges, includes in the lower area a locating tab 24 the particular shape of which is such that it can slide in the groove 60 between the upsets 61 and 62. Here, in this example, this locating tab 24 forms a locating lug of rectangular shape complementary to the shape of the groove 60.

When assembling the control electronic card 21 into the housing 50 the groove 60 therefore guides the locating lug toward the connecting orifices 55a and 55b.

As this guidance is longitudinal, that is to say from the front toward the rear of the lighting device, the ends of the connecting pins 25a and 25b are guided as far as the connecting orifices 55a and 55b and are located exactly to pass through them with minimum stresses on the connecting pins 55a and 55b. Thereafter the groove 60 continues to guide the locating lug 24 until the latter bears on the abutment 65. The control electronic card 21 and in particular its part connecting it to the electrical power supply is therefore located correctly.

The connecting pins in accordance with the invention and more particularly in this example can also be rectilinear and oriented from front to rear. This therefore makes it possible to reduce the stresses on the connecting pins 55a and 55b. This is all the more beneficial if, as in the example shown, the card is stacked in the housing 50 from the front toward the rear, the connecting pins 25a and 25b being fixed perpendicularly to this control electronic card 21 and extending toward the rear of the housing 50.

As can be seen in the figures, the locating tab 24 is situated on the periphery of the control electronic card 21 so as to be as close as possible to the connection of the pins 25a and 25b to this card 21.

To facilitate engaging the locating tab 24 in the groove 60, the upsets 61 and 62 may include chamfers 63 at the entry of the groove 60.

The mask 100 includes a part forming an embellisher 116. The latter includes a central opening 114. Once the fog lamp has been assembled, the mask 100 surrounds the lens 1, its part for deflecting the light rays, hereinafter the optical part 4, being accommodated in the central opening 114. From the outside, seen from in front, it is virtually only this optical part of the lens 1 and the front face of the embellisher 116 of the mask 100 that are visible.

As shown in FIGS. 8 and 9, the mask 100 includes at the rear of the embellisher 116 a bearing member 117 that extends longitudinally toward the rear of the housing 50. The latter lug is inside the groove 60 of the housing, between the embellisher 116 and the front of the locating tab 24. This bearing member bears against this locating tab 24 and presses it against the abutment 65.

When mounting the mask 100 in the housing 50, notably by longitudinal stacking toward the back wall 80, the bearing member 117 is engaged in the groove 60 and guided by the latter until the mask 100 is pushed in completely. This complete pushing in comes about when teeth 112 situated at the periphery of the embellisher 116 nest elastically in holes 51 of the housing 50. The final nesting of the mask 100 therefore presses the lens 1 via its protuberances 101, which may be elastic, and the locating tab 24 via its bearing member 117.

The outer lens 54 then closes the housing 50 and is sealed to it, for example by vibration welding.

This outer lens 54 must often be located with a precise orientation, notably because of its markings. This location is particularly difficult when, as in the nonlimiting example shown, this outer lens 54 is round.

To this end, the outer lens includes poka-yoke means, also known as a poka-yoke.

In accordance with one embodiment of the invention, the mask 100 includes a poka-yoke orifice 118 in front of the embellisher 116. It may for example correspond to a protuberance on the rear face of the outer lens 54.

In accordance with one embodiment of the invention, this poka-yoke orifice 118 is aligned with the bearing member 117. This alignment makes it possible to avoid any visible shrink mark on the embellisher 116. In fact, because of the rearward extent of the bearing member 117, when removing the mask from the mould, a shrink mark would be produced and would be visible from the other side of the embellisher 116, that is to say on its front face. To avoid this esthetic discomfort, the poka-yoke orifice 118 is aligned with the bearing member 117. Because of this, if there is any shrink mark, it is formed in this orifice and is not visible or not noticeable.

Note that the housing may also include an additional poka-yoke 67 intended to cooperate with a complementary shape on the outer lens 54.

To encourage heat dissipation and to favor the compactness of the lamp, the back wall of the housing 50 may include an opening through which the fins of the heatsink 17 pass. In this case the lamp includes an annular seal 58 in order to provide a seal between the heatsink 17 and said housing 50. It could also include a ventilation device 57 for establishing communication between the enclosure 52 and the outside.

In accordance with an embodiment that is not shown, said emission device may be mounted from the rear, and said housing closed at its longitudinal end opposite the outer lens by said light source support.

In accordance with one implementation possibility, said light source support 17 may have holes 92 through it. The holes 92 passing through it are arranged so as to allow the forks 11 of the hinge portion to pass through it and are sufficiently wide to allow the relative movement of the fork 11. This facilitates longitudinal mounting of the lens 1 on the housing and through the support 17.

It is possible to produce the hole 92 passing through the light source support 17 between the articulation arms 18 of the light source support 17.

Said optical part 4 extends, for example, from arms 7 of said hinge portion 5 and radially away from the rotation axis 3. In other words, said lens 1 includes flanks extending in the direction of said rotation axis 3 from a front area 8 of said lens 1, said front area 8 being the part of said lens 1 farthest from the rotation axis 3. Said optical part 4 of the lens 1 in particular lies on either side of said front area 8.

The arms 7 are situated on either side of said optical part 4, in the direction of the rotation axis 3. They include, for example, the journals 9 for articulation of the lens 1 about the rotation axis 3. The journals 9 have a cylindrical shape and are oriented along the rotation axis 3. The lighting device is configured to allow the journals 9 to rotate on themselves about the rotation axis 3 and consequently to allow the lens 1 as a whole to rotate about the same axis.

Here said mobile hinge portion 5 further includes means for driving rotation of the lens 1. Said drive means include, for example, at least one fork 11 that is ribbed and intended to cooperate with an adjuster screw 12 oriented transversely, notably orthogonally, to the rotation axis 3 and/or to said ribs.

Here the forks 11 are parts of said journals 9. They include lateral flanks 13 oriented radially relative to the rotation axis. Said lateral flanks 13 of the forks 11 include ribs 14 situated facing one another from one of said lateral flanks 13 to the other. The ribs 14 thus define a counterpart to a thread 15 situated at the level of the adjuster screw 12.

The drive means may be located on either side of said optical part 4 of the lens 1, along the rotation axis 3. This makes it possible to choose to place the adjuster screw 12 on the right or on the left when assembling the device.

Said arms 18 of the support are intended to cooperate with said mobile hinge portion 5 of the lens 1, in particular the journals 9, so as to impart to said lens 1 a degree of freedom in rotation about the rotation axis 3 when acted on by the adjuster screw 12.

The arms 18 of the support are in one piece with the support 17 of the light source 6 and extend in a direction perpendicular to the rotation axis 3. These arms 18 of the support have at the distal end a fixed hinge portion 20 adapted to receive said journals 9 and to leave them free to rotate about the rotation axis 3. In this example, this is a concavity 20 the surface of which is a portion of a cylinder complementary to the shape of the journals 9.

The mask 100 forms a presser element. As shown in FIG. 1, this presser element is stacked and fixed in the housing 50 of the lighting device. Being stacked in this way, it presses the journals 9 into the concavities 20 of the support 17. FIGS. 8 and 9 show the lighting device without the housing 50 so that this pressing action can be seen.

The mask presses the journals 9, and therefore the lens 1, against the support 17 of the light source via the protuberances 101, the latter also having a shape complementary to the shape of the journals 9. The lens is therefore fixed directly to the support 17 of the light source and hinged to rotate between the mask 100 and the support 17.

The present invention is particularly advantageous in the context of a fog light. However, it could be applied to other lighting devices.

For example, to lighting devices with a lens rotating about a vertical axis to produce a mobile portion of a light beam, notably a first beam with an oblique or vertical cut-off line, this first beam being intended to be combined with a beam with a horizontal cut-off line.

In accordance with one embodiment of the invention, this combination may be applied to a lighting device in accordance with the invention generating an elementary light beam with an oblique or vertical cut-off intended to be combined with a second elementary light beam with a horizontal cut-off line. The oblique cut-off beam moving horizontally by virtue of actuation of the optical element, for example as a function of turns executed by the vehicle equipped with the lighting device, or again as a function of vehicles approaching in the opposite direction.

1-16. (canceled)

17. A motor vehicle lighting device comprising:
a housing;
an outer lens closing a front opening of the housing and transparent to allow light rays emitted by the lighting device to pass through the outer lens;
an electronic card inside the housing connected directly or indirectly or configured to be connected directly or indirectly to a light source, the electronic card including a locating tab;
the housing including at least one locating portion configured with the locating tab so that the electronic card is located relative to the housing by contact engagement of the locating portion and the locating tab.

18. A lighting device according to claim 17, wherein the locating tab is formed on a portion of a peripheral edge of the electronic card.

19. A lighting device according to claim 17, wherein the locating tab and the locating portion are configured to slide one against the other when assembling the electronic card into the housing.

20. A lighting device according to claim 17, wherein the housing includes connecting orifices, the electronic card including connecting pins for supply of electrical power to the electronic card, the connecting pins passing through the connecting orifices.

21. A lighting device according to claim 20, wherein the locating tab is formed on a portion of a peripheral edge of the electronic card that is nearest to the connecting pins.

22. A lighting device according to claim 20, wherein the connecting pins and the connecting orifices are oriented in a rectilinear direction from the front toward the rear of the housing.

23. A lighting device according to claim 20, wherein the connecting orifices are on a back wall or rear of the housing.

24. A lighting device according to claim 17, wherein the locating portion is a groove in a wall of the housing, the locating tab being accommodated in the groove.

25. A lighting device according to claim 24, wherein the groove extends in a rectilinear direction from the front toward the rear of the housing.

26. A lighting device according to claim 24, wherein the housing includes a globally cylindrical wall closed at the rear by a back wall, the cylindrical wall including a cylinder axis extending from the front toward the rear of the housing, the groove being formed on the cylindrical wall.

27. A lighting device according to claim 20, further comprising a mask located between the electronic card and the outer lens, the mask including a bearing member bearing on the locating tab and accommodated inside the groove.

28. A lighting device according to claim 17, further comprising a mask located between the electronic card and the outer lens, the mask including a bearing member bearing on the locating tab.

29. A lighting device according to claim 27, wherein the bearing member extends in a rectilinear direction from the front toward the rear of the housing.

30. A lighting device according to claim 27, wherein the mask includes a poka-yoke orifice facing the outer lens, the poka-yoke orifice being aligned with the bearing member.

31. A lighting device according to claim 17, wherein the light source is a light-emitting diode.

32. A lighting device according to claim 17, wherein the lighting device is a fog lamp.
